(19) United States
(12) Patent Application Publication
(10) Pub. No.: US 2023/0009069 A1
(43) Pub. Date: Jan. 12, 2023

(54) CONNECTOR DEVICE

(71) Applicant: Noble House Home Furnishings, LLC, Chatsworth, CA (US)

(72) Inventor: Venkataramu Bangalore, Chatsworth, CA (US)

(21) Appl. No.: 17/824,155

(22) Filed: May 25, 2022

Related U.S. Application Data
(60) Provisional application No. 63/195,029, filed on May 30, 2021.

(51) Int. Cl. F16B 12/10

(52) U.S. Cl. CPC F16B 12/10

(57) ABSTRACT

A connector device comprises a male taper component having a base and a tapering bracket extending therefrom, and a female taper component having a tapering channel. The tapering bracket is releasably received within the tapering channel to effect a firm connection between the male taper component and the female taper component.

### CROSS REFERENCE TO RELATED APPLICATIONS

This application claims the benefit of U.S. Provisional Patent Application No. 63/195,029 filed May 30, 2021, the contents of which are incorporated herein by reference in their entirety.

### FIELD AND BACKGROUND OF THE INVENTION

This invention relates to a locking or connection system wherein two objects are connected to each other. The invention is particularly useful in assembling various parts of a furniture item together by the end user, although the invention is not limited to such a use.

It is becoming more prevalent that furniture items as well as other consumer products are shipped to an end user in a broken down or disassembled condition, and it is the task of the end user to assemble the product before it can be used. This is a situation which is increasingly encountered in the growing field of e-commerce where people buy products remotely, such as over the internet, and need to assemble them from compacted multiple and individual components. This itself is the result of attempting to keep shipping and transportation costs, and the size of the container, within reasonable limits. A consequence of this development is that product manufacturers are constantly looking for more convenient methods and structures in which to fasten components together more efficiently, at the same time making it easier for the end user, and avoid having to go through complicated steps or even unintelligible instructions to achieve assembly. The present invention is one which addresses this issue.

### SUMMARY OF THE INVENTION

According to one aspect of the invention, there is provided a connector device comprising a male taper component having a base and a tapering bracket extending therefrom and a female taper component having a tapering channel, the tapering bracket being releasably received within the tapering channel to effect a firm connection between the male taper component and the female taper component.

The invention may further comprise a snap on insert member for securing the tapering bracket in the tapering channel to prevent separation thereof as long as the snap on insert member is installed.

The male taper component may comprise a base portion and the tapering bracket on the base portion, the tapering bracket tapering from one larger end thereof adjacent the base portion to an opposing smaller end thereof, the tapering bracket tapering from the larger end to the smaller end. The base portion may have connecting means for connecting the base portion to a first object. Further, the tapering bracket may have a lower step portion and an upper step portion, the lower step portion being wider than the upper step portion.

In one embodiment, the female taper component comprises a housing having a front end and a rear end, the housing defining the tapering channel, wherein the tapering channel tapers from the front end to the rear end such that the front end of the tapering channel is larger than the rear end of the tapering channel. The housing of the female taper component may have a connecting means for connecting the housing to a second object. Further, the tapering channel may have a lower step portion and an upper step portion, the lower step portion being wider than the upper step portion.

In one form of the invention, the male taper component has a snap receiving aperture for receiving the snap on insert and the female taper component has a snap receiving aperture for receiving the snap on insert, the snap receiving apertures of the male taper component and the female taper component being aligned when the tapering bracket of the male taper component is fully inserted in the tapering channel of the female taper component.

The snap on insert member may comprise a shaft portion having a head portion at a first end and a pair of generally opposing engagement clamps at a second end, and a slot in the shaft portion between the engagement clamps which facilitate a small degree of radial compression movement of the engagement clamps. There may be a ring member on the male taper component for receiving the engagement clamps of the snap on insert member when the snap on insert member is inserted into the snap on apertures of the female taper component and the male taper component.

In use, the male taper component attaches to a first furniture piece and the female taper component attaches to a second furniture piece so the first and second furniture pieces are connected to each other when the male taper component and the female taper component are connected to each other.

According to another aspect of the invention, there is provided a method of connecting a first object to a second object comprising: providing a male taper component having a base and a tapering bracket extending therefrom; providing a female taper component having a tapering channel; and connecting the tapering bracket within the tapering channel to effect a firm connection between the male taper component and the female taper component.

The method may further comprise providing a snap on insert member for securing the tapering bracket in the tapering channel and preventing separation between the two as long as the snap on insert member is installed. The snap on insert may be releasably secured through aligned snap on apertures formed in the male taper component and the female taper component.

Preferably, the tapering bracket is formed so as to have a smaller profile at its front end, and the tapering channel is formed so as to have a larger profile than profile than the tapering bracket at entry location of the tapering channel, so that complete alignment between the tapering bracket and the tapering channel is not required prior to connection of the two, and the action of inserting the tapering bracket into the tapering channel facilitates such alignment.

According to yet a further aspect of the invention, there is provided a connector device comprising: a male taper component having a tapering bracket extending therefrom, the tapering bracket having a first larger end and a second smaller end; and a female taper component having a tapering channel having an opening end and an inner end wherein the opening end is larger than the inner end, the tapering bracket being releasably inserted second smaller end leading within the tapering channel to effect a firm connection between the male taper component and the female taper component, the tapering bracket being decreasingly movable within the tapering channel during insertion, and substantially immovable relative to the tapering channel when fully inserted therein.

Such a connector device may further comprise a snap on insert member for securing the tapering bracket and the tapering channel relative to each other to prevent separation thereof as long as the snap on insert member is installed.

This invention relates therefore to a locking or connection device. More particularly, the invention relates to a locking device for holding two objects together, the locking device having a first component in or on one of the objects and a second component in or on the other object. The locking device of the invention has a structure and configuration which facilitates easier alignment of the two objects to be connected, and facilitates a secure fastening between the two objects as the first and second components engage each other during the connection operation.

An interlocking of components and the design thereof is a unique way of locking together disassembled or knock down members or structures, and may be particularly useful and beneficial for locking together components or parts of a piece of furniture, especially without the need to use any fasteners or other tools. The sale of furniture items in a knock down format, or in an unassembled condition, is becoming more and more prevalent in modern commerce and e-commerce, and the assembly thereof by the buyer or owner or end user is thus a significant consideration for manufacturers who would of course prefer to make it as easy and as painless as possible to assemble the furniture parts quickly and effectively, without much of the frustration that may often accompany such a task.

The design of the invention, in one embodiment, uses an innovative variant or version of the reverse taper, which has a twofold benefit. First, this mechanism facilitates the alignment of the two mating parts, so that a general alignment can be easily achieved, and the connection process using the connector of the invention will thereafter complete the alignment. Second, the connector of the invention also interlocks and gradually and increasingly constrains the degree of freedom of relative movement, as the furniture parts are brought closer together, ultimately forming the near perfectly aligned parts and their connection to each other in a secure and effective manner. The final assembly therefore consists of the merging of the male and female taper inserts with a snap-on insert holding the two together in the final assembled position so that the parts or furniture components are securely connected and fastened to each other.

### BRIEF DESCRIPTION OF THE DRAWINGS

In the drawings:

FIG. 1 is a front perspective view of a male taper component of the connector device in accordance with one aspect of the invention;

FIG. 2 Is a front perspective view of a female taper component of the connector device;

FIG. 3 is a perspective view of a snap on member of the connector device for use with the male taper component and the female taper component;

FIG. 4 is a top perspective view of the male taper component, female taper component and snap on member in the fastened or connected condition;

FIG. 5 is a bottom perspective view of the male taper component, female taper component and snap on member in the fastened or connected condition;

FIG. 6 is a bottom perspective view of the male taper component, the female taper component, and the snap on member when adjacent to each other but before they are fastened together, showing the respective positions allowing alignment and subsequent constraining and connecting of the various components; and

FIG. 7 is a schematic view showing horizontal and vertical axes illustrating the form of constraining and connection used by the connection device of the present invention.

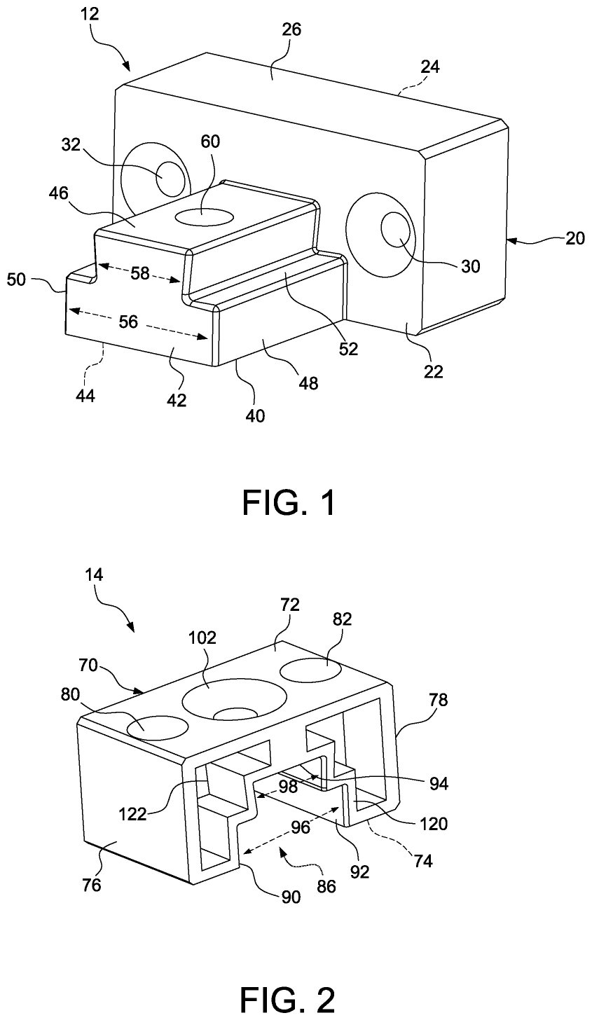

### DETAILED DESCRIPTION OF THE INVENTION

The invention will now be described with reference to the accompanying drawings, which show various parts of a connector device 10 in accordance with one aspect of the invention. Variations and different embodiments of the connector device 10 as illustrated will also form part of the invention.

The connector device 10 of the invention comprises a male taper component 12, and a female taper component 14. These components 12 and 14 snap or merge together when properly connected to each other and are held firmly in a secure connected position by a snap on insert 16, which holds these parts together in a manner as will be described below.

The male taper component 12 is attached to a first part of a disassembled item of furniture (not shown) while the female taper component 14 is attached to a second part of a disassembled item of furniture (also not shown). As such, when the male taper component 12 is connected to the female taper component 14, it follows that first part of the furniture item will be fastened to or connected with the second part of the furniture item. Note that it is certainly within the scope of the invention that objects or parts which are connected to each other using the connector device 10 of the invention need not be items of furniture, but can be anything else where the type of connection provided by the invention is useful or appropriate.

The male taper component 12 comprises a base 20 having a front surface 22, a rear surface 24, and side walls 26. A pair of lateral apertures 30 and 32 are provided in the base 20, by mean of which the base 20 can be securely fastened to an item of furniture (not shown), or other object, as indicated above. The male taper component 12 further comprises a connector bracket 40 projecting forwardly and away from the front surface 22 of the male taper component 12. The bracket 40 has a front face 42, a bottom surface 44, and a top surface 46. There are also provided side wall surfaces 48 and 50, each of which has a stepped surface 52. Therefore, the connector bracket 40 has a lower and wider portion 56 and an upper and narrower portion 58 when viewed from the front face 42 vantage point. The connector bracket 40 further comprises an aperture 60, which is for receiving the snap on insert 16, as will be described.

FIG. 2 of the drawings illustrates the female taper component 14 of the connector device 10 of the invention. The female taper device 14 comprises a housing 70 having a top surface 72, a bottom surface 74 and side wall surfaces 76 and 78 respectively. A pair of lateral apertures 80 and 82 are provided. The lateral apertures 80 and 82 may be used for the passage of bolts or screws therethrough in order to securely connect the female taper component 14 to a part of an item of furniture, which in turn allows the furniture part to be connected or fastened to another part of an item of furniture, which have been dissembled or separately constructed and manufactured for transportation and storage prior to assembly by the end user.

In the bottom surface 74 of the housing 70, there is formed a channel 86. In use, the channel 86 will receive the connector bracket 40, as will be described. The channel 86 has side walls 90 and 92, as well as a top wall 94. Each of the side walls 90 and 92 is of a stepped configuration. The channel 86 therefore has a lower and wider opening 96 and an upper and narrower opening 98. These openings 96 and 98 are of approximately the same height, although their heights may be different in different embodiments of the invention. The female taper component 14 further comprises an aperture 102 in a generally central location on the housing 70 and extending from the top surface 72 down to and through the top wall 94 of the channel 86.

In the female taper component 14, the space between the channel 86 and the top surface 72, bottom surface 74 and side wall surfaces 76 and 78 may be either solid or may comprise a space, as shown in the embodiment shown in the drawings. The version may be determined based on the required strength or resilience of the connection device 10, which may depend upon the furniture item specifications and the load which the furniture item may be intended to support.

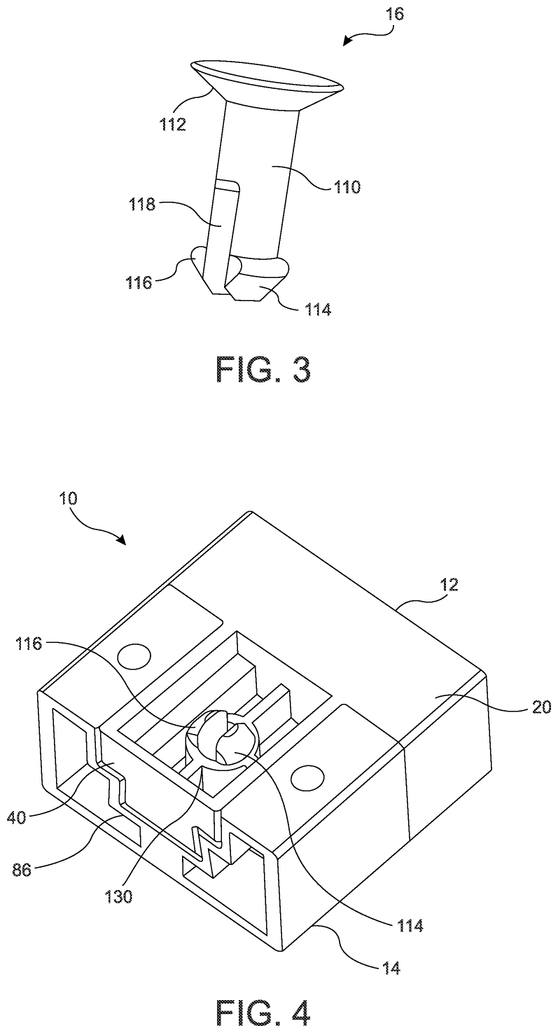

FIG. 3 of the drawings shows the snap on insert 16. The snap on insert 16 has a shaft portion 110, a head portion 112 at one end of the shaft portion 110, and engagement clamps 114 and 116 at the other end of the shaft portion 110. A slot 118 is formed in the shaft portion 110 at the area of the engagement clamps 114 and 116, the slot 118 allowing the engagement clamps 114 and 116 to have some resilience so that they are capable of being squeezed together by small distance, roughly equal to at least twice the distance by which one of the engagement clamps 114 and 116 extend outwardly from the surface of the shaft portion 110.

Referring to the male taper component 12, the connector bracket 40 is tapered so that is larger at the point where it connects to the front surface 22 of the base 20, and tapers gradually to narrow slightly at the front face 42. In like manner, and referring to the female taper component 14, the channel 86 is tapered so that it is larger at its front surface 120 and gradually decreases in dimension to be narrower at its rear surface 122.

In use, the male taper component 12, attached to a part of a furniture item, is attached to the female taper component 14, which is attached to another part of a furniture item, in order to effect a secure fastening of the furniture parts to each other. In this regard, the attachment is effected by inserting the connector bracket 40 into the channel 86, and thereafter securing the connector bracket 40 when in the fully inserted position within the channel 86 by means of the snap or insert 16 which passes through the aperture 102 in the housing 70 and aperture 60 in the connector bracket 40. These apertures 102 and 60 are aligned, or register with each other, when the connector bracket 40 is fully inserted in the channel 86, and the snap on insert 16 ensures that this full insertion is maintained at all times. When the connector bracket 40 is fully inserted in the channel 86, the tolerances therebetween will preferably be very low or close to zero so that relative movement between the two is essentially prohibited for practical purposes and a firm and stable connection is therefore established.

The tapering of both of the connector bracket 40 and the channel 86 helps to align the male taper component 12 and the female taper component 14 prior to full connection. It will be appreciated that, in this constructions, the front end 42 of the connector bracket 40 is of slightly smaller dimension than that of the channel 86 at the front surface 120 thereof. Therefore, some relative movement between the connector bracket 40 within the housing 70 is permitted at the point where the front face 42 is about to enter the channel 86, or is at the threshold thereof. This is a useful feature, since it does not require the person assembling the parts to orient the parts in the exact position prior to the connection. Some tolerance or leeway in bringing the parts together is allowed by the configuration. This may save time and energy in exactly aligning the parts, and reduce assembly frustration, making it easier and somewhat more user friendly.

Once the smaller front face 42 is placed in the channel 86, further insertion of the connector bracket 40 will result in a tighter and closer connection, the more the connector bracket is slid into the channel 86. By the point at which the connector bracket 40 is fully inserted in the channel 86, tolerances are reduced to near zero since the front face 42 is of substantially the same dimension as the rear surface defined by the channel 86, and the connector bracket 40 dimension at the point at which it is connected to the front surface 22 of the base 20 is the same size as the opening to the channel 86. The connector bracket 40 will therefore be tightly and firmly secured within the channel 86, with no or minimal side to side or up and down movement possible. Once the snap on insert 16 is inserted, as described above, back and forth movement of the connector bracket 40 in the channel 86 will also be prevented. The connection therefore becomes complete and secure with substantially no relative movement between the components permitted.

The snap on insert 16 is inserted in the aperture 102 of the housing 70. This aperture 102 includes an angled or beveled surface so that the head portion 112 of the snap on insert 16, similarly configured in terms of shape and dimension, is received therein and the head portion 112 has an upper surface which will be substantially flush with the top surface 72 of the housing 70. The shaft portion 110 passes through the housing 70 and enters the aperture 60 of the connector bracket 40, passing through this bracket 40. When fully inserted, the snap on insert 16 will pass through the connector bracket 40 completely and the engagement clamps 114 and 116 will be squeezed toward each other as they proceed along the aperture, constricting the slot 118, as the inclined surfaces of the engagement clamps 114 and 116 pass through a ring 130 on the connector bracket 40 underside. Once the engagement clamps 114 and 116 have passed through the ring 130, they will snap apart again to their default position, at the same time engaging the ring with their flat surfaces so that the snap on insert 16 cannot be removed therefrom unless and until the engagement clamps 114 and 116 are pushed together so that they will be narrow enough to get through the ring 130 and allow further withdrawal from both the male taper component 12 and the female taper component 14.

FIG. 4 of the drawings shows a bottom perspective view of the male taper component 12 and the female taper component 14 fully connected to each other. Further, these taper components 12 and 14 are held in a locked position by the snap on insert 16, so that movement between the taper components 12 and 14 is, practically, no longer possible. The furniture (or other) parts to which the male taper component 12 and the female taper component 14 are respectively attached are, as a consequence, firmly and substantially immovably fastened to each other in this solid connection.

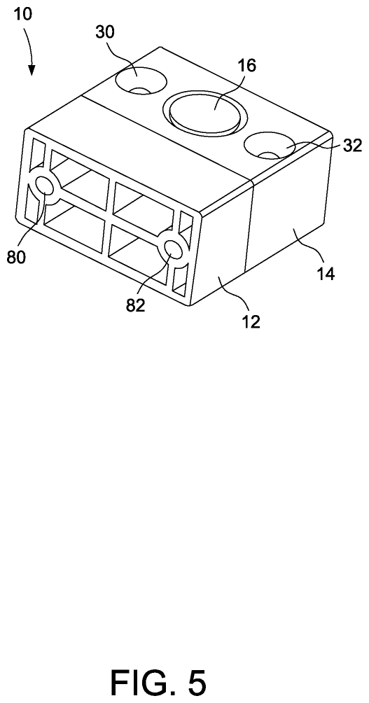

FIG. 5 of the drawings shows a top perspective view of the male taper component 12 and the female taper component 14 fully connected to each other, as shown in FIG. 4 of the drawings.

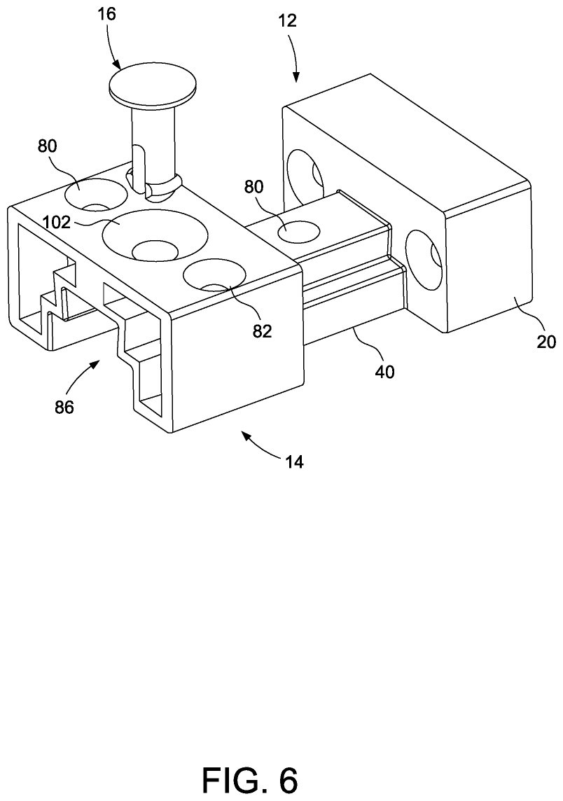

FIG. 6 of the drawings shows a bottom perspective view of the male taper component 12 and the female taper component 14 adjacent but not fully connected to each other. The position of the snap on insert 16 is shown above the aperture in which it will be inserted. The connection of the male taper component 12 and the female taper component 14 ensures that there will be no up and down or left and right lateral movement between them. Inserting the snap on insert 16 ensures that there will, furthermore, be no back and forth movement between the taper components 12 and 14, rounding out the effectiveness of the connection, which can be carried out in an easy to use fashion, due to the tapering characteristics of the connector bracket 40 and the channel 86. It should be noted that different configurations of the tapering characteristics can be used, such as for example only up and down or only side to side tapering or only partial tapering, and the structure described and illustrated can be varied in a manner which will achieve the same result. This result is the ability to have some leeway when aligning the male and female taper components 12 and 14, and the gradual tightening as the components engage each other further until a tight and firm connection is achieved.

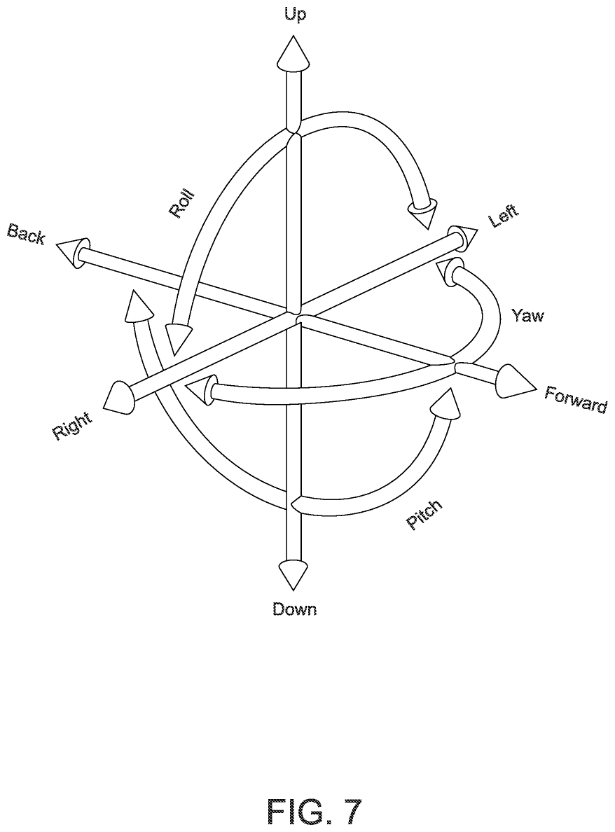

FIG. 7 of the drawings shows a schematic mathematical representation of the three axes, vertical and horizontal, and the use of such axes as applied to the connector device 10 of the present invention.

As will be appreciated, in any mechanical design assembly, constraining the motion on all degrees of freedom can be very important. As will be seen in the accompanying figures, the degrees of freedom and the relative motion is illustrated, so that the connector device of the invention has broad and easy applications.

Similarly, in the present invention design, the tapering components or items are mounted on parts of the furniture to be assembled. The male and female component dimensions cause them to enter and constrain the motion in the up and down as well as the left and right direction. This is possible due to reverse taper configuration. The strength of the assembly may be determined based on the taper angle. This angle can be anywhere between 10-30 degrees in one embodiment of the invention, but other angles may well be suitable in certain situations and applications. Further, to avoid the forward and backward movement, the snap-on pin is inserted. This has the effect of constraining all motions making the assembly secure.

This mechanism can be used on any of a large number of furniture designs which can incorporate this design. The fastening mechanism may be effected without the use of any tool and hardware.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A connector device comprising:
a male taper component having a base and a tapering bracket extending therefrom; and
a female taper component having a tapering channel, the tapering bracket being releasably received within the tapering channel to effect a firm connection between the male taper component and the female taper component.

2. A connector device as claimed in claim 1 further comprising a snap on insert member for securing the tapering bracket in the tapering channel to prevent separation thereof as long as the snap on insert member is installed.

3. A connector device as claimed in claim 1 wherein the male taper component comprises a base portion and the tapering bracket on the base portion, the tapering bracket tapering from one larger end thereof adjacent the base portion to an opposing smaller end thereof, the tapering bracket tapering from the larger end to the smaller end.

4. A connector device as claimed in claim 3 wherein the base portion has connecting means for connecting the base portion to a first object.

5. A connector device as claimed in claim 3 wherein the tapering bracket has a lower step portion and an upper step portion, the lower step portion being wider than the upper step portion.

6. A connector device as claimed in claim 1 wherein the female taper component comprises a housing having a front end and a rear end, the housing defining the tapering channel, wherein the tapering channel tapers from the front end to the rear end such that the front end of the tapering channel is larger than the rear end of the tapering channel.

7. A connector as claimed in claim 6 wherein the housing of the female taper component has a connecting means for connecting the housing to a second object.

8. A connector device as claimed in claim 7 wherein the tapering channel has a lower step portion and an upper step portion, the lower step portion being wider than the upper step portion.

9. A connector device as claimed in claim 2 wherein the male taper component has a snap receiving aperture for receiving the snap on insert and the female taper component has a snap receiving aperture for receiving the snap on insert, the snap receiving apertures of the male taper component and the female taper component being aligned when the tapering bracket of the male taper component is fully inserted in the tapering channel of the female taper component.

10. A connector device as claimed in claim 2 wherein the snap on insert member comprises a shaft portion having a head portion at a first end and a pair of generally opposing engagement clamps at a second end, and a slot in the shaft portion between the engagement clamps which facilitate a small degree of radial compression movement of the engagement clamps.

11. A connector device as claimed in claim 10 further comprising a ring member on the male taper component for receiving the engagement clamps of the snap on insert member when the snap on insert member is inserted into the snap on apertures of the female taper component and the male taper component.

12. A connector device as claimed in claim 1 wherein the male taper component attaches to a first furniture piece and the female taper component attaches to a second furniture piece so the first and second furniture pieces are connected to each other when the male taper component and the female taper component are connected to each other.

13. A method of connecting a first object to a second object comprising:
providing a male taper component having a base and a tapering bracket extending therefrom;
providing a female taper component having a tapering channel; and
connecting the tapering bracket within the tapering channel to effect a firm connection between the male taper component and the female taper component.

14. A method as claimed in claim 13 further comprising providing a snap on insert member for securing the tapering bracket in the tapering channel and preventing separation between the two as long as the snap on insert member is installed.

15. A method as claimed in claim 14 wherein the snap on insert is releasably secured through aligned snap on apertures formed in the male taper component and the female taper component.

16. A method as claimed in claim 13 wherein the tapering bracket is formed so as to have a smaller profile at its front end, and the tapering channel is formed so as to have a larger profile than profile than the tapering bracket at entry location of the tapering channel, so that complete alignment between the tapering bracket and the tapering channel is not required prior to connection of the two, and the action of inserting the tapering bracket into the tapering channel facilitates such alignment.

17. A connector device comprising:
a male taper component having a tapering bracket extending therefrom, the tapering bracket having a first larger end and a second smaller end; and
a female taper component having a tapering channel having an opening end and an inner end wherein the opening end is larger than the inner end, the tapering bracket being releasably inserted second smaller end leading within the tapering channel to effect a firm connection between the male taper component and the female taper component, the tapering bracket being decreasingly movable within the tapering channel during insertion, and substantially immovable relative to the tapering channel when fully inserted therein.

18. A connector device as claimed in claim 17 further comprising a snap on insert member for securing the tapering bracket and the tapering channel relative to each other to prevent separation thereof as long as the snap on insert member is installed.
